(19) United States
(12) Patent Application Publication
(10) Pub. No.: US 2014/0004361 A1
(43) Pub. Date: Jan. 2, 2014

(54) SUBSTRATE CORES FOR LASER THROUGH HOLE FORMATION

(71) Applicants: Nikhil Sharma, Chandler, AZ (US); Chong Zhang, Chandler, AZ (US); Tao Wu, Chandler, AZ (US); Islam A. Salama, Chandler, AZ (US)

(72) Inventors: Nikhil Sharma, Chandler, AZ (US); Chong Zhang, Chandler, AZ (US); Tao Wu, Chandler, AZ (US); Islam A. Salama, Chandler, AZ (US)

(21) Appl. No.: 13/536,709

(22) Filed: Jun. 28, 2012

(51) Int. Cl. B32B 27/02; B23K 26/38

(52) U.S. Cl. 428/448; 428/500; 219/121.71

(57) ABSTRACT

Substrate cores for laser through hole formation are described. Substrate core embodiments include a plurality of reinforcement material layers and a microfiller loaded resin disposed between the plurality of reinforcement material layers. Microfiller and reinforcement materials are selected to reduce opto-thermal mismatch for a laser of a predetermined bandwidth. In embodiments, the reinforcement material may include a fibrous polymer, reducing the thermal contrast with the microfiller loaded resin, and/or include a chromophore that absorbs within the laser bandwidth. In further embodiments, the microfiller is of a material having a high melting temperature to reduce thermal contrast with the reinforcement material.

### TECHNICAL FIELD

Embodiments of the present invention generally relate to formation of laser through holes in a package substrate core, and more particularly relate to methods and materials to control core fiber protrusion.

### BACKGROUND

FIG. 1A depicts a microelectronics package 190 wherein an integrated circuit (IC) chip 180 is affixed to a printed circuit board (PCB) 170. The chip 180 is affixed, (e.g., by solder) to a package substrate 120 by first level interconnects 181, the substrate in turn is soldered onto the PCB 170 by second level interconnects 171. One way to enable vertical interconnection of the PCB 170 and chip 180 is by fabricating metal plated through-holes 100 in the substrate core 103 (the support over which build-up layers 113 are formed). Microvias 108 and redistribution layers 107 complete the vertical interconnection. In conventional substrate manufacturing, formation of the through-hole 100 is usually accomplished with mechanical drilling of the core 103.

As further shown in FIG. 1B, the substrate core 103 is typically a composite material that includes a polymer matrix 140 loaded with microfiller 150, such as silica particles, and a reinforcement material 130, such as glass fiber. The reinforcement provides structural rigidity to the matrix and microfillers are usually added to the matrix to lower the coefficient of thermal expansion (CTE), reduce shrinkage, and to reduce flammability. Multiple layers of glass fabric impregnated with filler loaded resin are pressed together between two copper (Cu) layers 145 to form a copper clad laminate (CCL) and this core 103 is then used as a starting precursor for fabrication of the package substrate 120.

As transistor gate width on the IC chip 180 is scaled, and/or a greater level of chip-level integration is achieved, a tighter level one interconnect pitch (e.g., C4 bump-pitch) necessitate the construction of smaller diameter through-holes in the core with reduced through-hole pitch. Increased package-level integration also necessitates the construction of smaller diameter through-holes in the core with reduce through-hole pitch. Advances in both chip-level and package-level integration favor more redistribution levels in a package substrate and a tighter through-hole pitch with smaller diameter through-holes. Mechanical through-hole drilling is usually the most expensive process in package substrate manufacture and the rate of drill bit wear and breakage increases significantly as the drill bit diameter decreases.

Laser drilling is a technique that might replace mechanical drilling for through-hole formation as it offers several advantages such as the ability to make extremely small diameter through-holes and has attractive throughput rates and operating costs. However, laser drilling is not well established for through holes in package cores, particularly those having a core thickness of 400 μm, or greater. One of the difficulties with core through-hole laser drilling is that the material-laser interaction is not well understood for the laminate substrate cores. Initial attempts have resulted in glass fiber protruding into a laser through-hole (LTH), as shown for the through-hole 100 in FIG. 1B. For the substrate core 103, the glass cloth fibers 105 protrude beyond the through-hole sidewall 110 defined by undercut (relative to the protruding fibers 105) of the resin 115. Because electroplating employed to plate fill metal 120 is conformal to the underlying surface, voids 125 and/or entrapped plating electrolytes may occur in the through-hole 100, which poses a reliability concern to the packaged device.

### BRIEF DESCRIPTION OF THE DRAWINGS

Embodiments of the present invention are illustrated by way of example, and not by way of limitation, and can be more fully understood with reference to the following detailed description when considered in connection with the figures in which:

FIG. 1A is a cross-sectional view of a conventional metal plated, mechanically drilled through-hole in a package substrate core;

FIG. 1B is a cross-sectional view of a conventional metal plated, laser drilled through-hole in a package substrate core;

FIG. 2A is a cross-sectional view of a metal filled, laser drilled through-hole in a package substrate core, in accordance with an embodiment of the present invention;

FIG. 2B is a cross-sectional view of a metal filled, laser drilled through-hole in a package substrate core, in accordance with an embodiment of the present invention;

FIG. 3 is an illustration of a schematic showing the interaction of laser light with a reinforced core material, in accordance with an embodiment;

FIG. 4 is an absorption spectra depicting an absorption delta between relative absorption amounts for resin, glass, and copper, that is reduced in embodiments of the present invention; and

FIG. 5 is an isometric view of a mobile computing device employing a package substrate with laser drilled through-holes, in accordance with an embodiment.

### DETAILED DESCRIPTION

In the following description, numerous details are set forth, however, it will be apparent to one skilled in the art, that the present invention may be practiced without these specific details. In some instances, well-known methods and devices are shown in block diagram form, rather than in detail, to avoid obscuring the present invention. Reference throughout this specification to “an embodiment” means that a particular feature, structure, function, or characteristic described in connection with the embodiment is included in at least one embodiment of the invention. Thus, the appearances of the phrase “in an embodiment” in various places throughout this specification are not necessarily referring to the same embodiment of the invention. Furthermore, the particular features, structures, functions, or characteristics may be combined in any suitable manner in one or more embodiments. For example, a first embodiment may be combined with a second embodiment anywhere the two embodiments are not mutually exclusive.

The terms “coupled” and “connected,” along with their derivatives, may be used herein to describe structural relationships between components. It should be understood that these terms are not intended as synonyms for each other. Rather, in particular embodiments, “connected” may be used to indicate that two or more elements are in direct physical or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause an effect relationship).

The terms “over,” “under,” “between,” and “on” as used herein refer to a relative position of one material layer or component with respect to other layers or components. As such, for example, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer.

In embodiments, a laser forms a through-hole a package substrate core. Generally, any laser drilling process employing a laser of any known wavelength, average power, pulse width, spot size, etc. may be utilized in the embodiments herein. A typical laser drilling machine for such a process entails a laser source, coupling optics (e.g., collimator, galvo minors, beam masks, etc.) and an x-y table upon which the substrate core material is disposed during processing. In the exemplary embodiment, the laser source is a CO₂ laser operable at a wavelength of 9.4 and 10.6 μm (microns). CO₂ lasers have an adequately small spot size for core via drilling applications (e.g., approximately 50 μm) and offer high average power (e.g., ˜150 W) for high throughput at low operating cost relative to other laser embodiments, such as, but not limited, to UV lasers (e.g., solid state and Excimer) and ultrafast IR (1.03-1.55 μm) and UV (Third-harmonic generation or “THG”) lasers which operate in the 248 nm-355 nm regime, have very small spot sizes (e.g., <15 μm) and low power (e.g., <5 W).

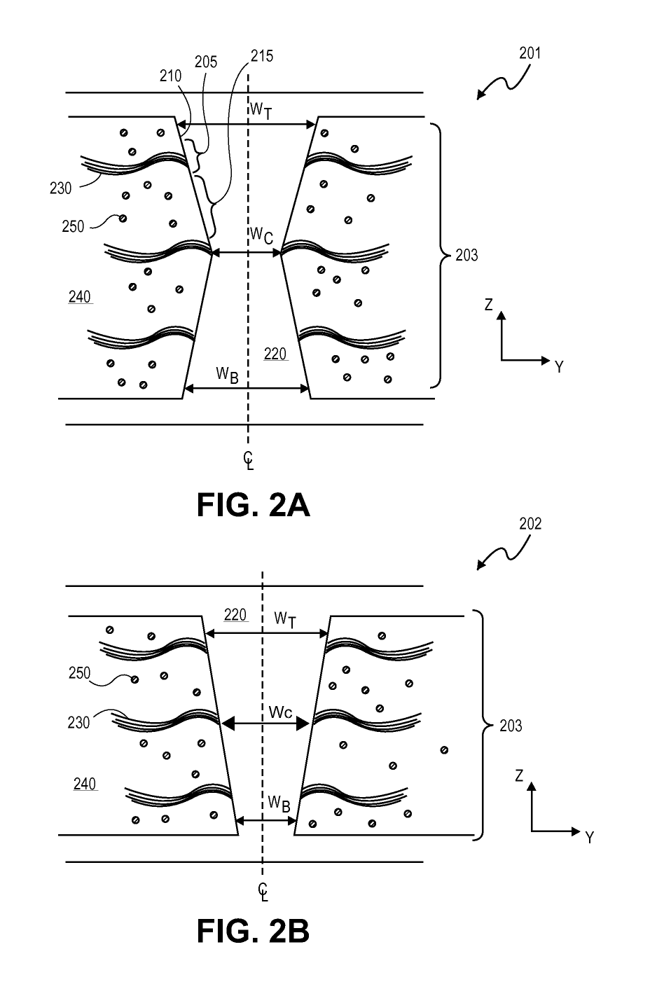

In embodiments, a tapered through-hole is formed in a package substrate core with a laser. Unlike mechanical drilling which typically forms a through hole with nearly vertical sidewalls, in embodiments of the present invention the LTH is tapered from at least one side. FIG. 2A is a cross-sectional view of a metal filled laser drilled through-hole 201 in a reinforced package substrate core 203, in accordance with an embodiment of the present invention. In this exemplary embodiment, there is a two-sided taper with a bottom width of the through-hole (W_{B}) and a top width of the through-hole (W_{T}) both being of a larger diameter than a center width of the through-hole (W_{C}). The two-sided taper is indicative of a two-sided laser drilling process. Such two-sided processes are employed in advantageous embodiments for better through-hole symmetry (relative to single-sided processing) for better filling of the fill metal 220 (e.g., plated copper), better positional accuracy due to reduced telecentric error of the scanning lens and better dimensional control of the bottom diameter (i.e., W_{B}), particularly where a CO₂ laser is employed because significant reflections from the bottom metal cladding (e.g., copper) can pose difficulty.

FIG. 2B is a cross-sectional view of a metal filled laser drilled through-hole 202 in a reinforced package substrate core 203, in accordance with an embodiment of the present invention. In this exemplary embodiment, there is a one-sided taper with through hole diameter increasing from bottom to top (i.e., W_{B}<W_{C<}W_{T}). The one-sided taper is indicative of a one-sided laser drilling process, which while offering process simplicity relative to two-sided laser drilling, lacks the bottom diameter dimensional control offered by two-sided laser drilling for at least the exemplary CO₂ laser embodiments.

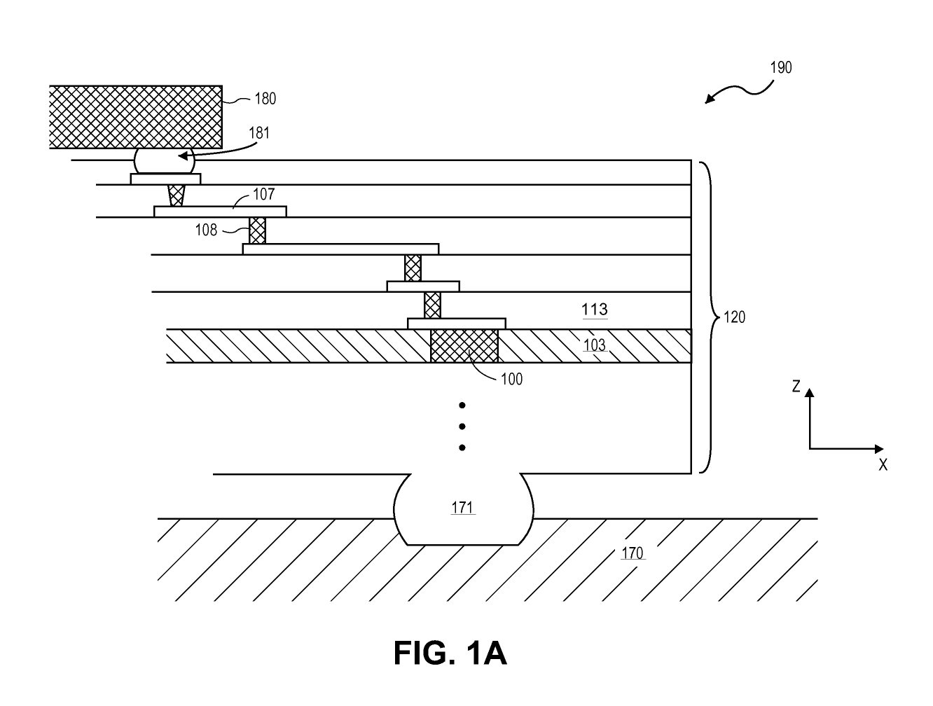

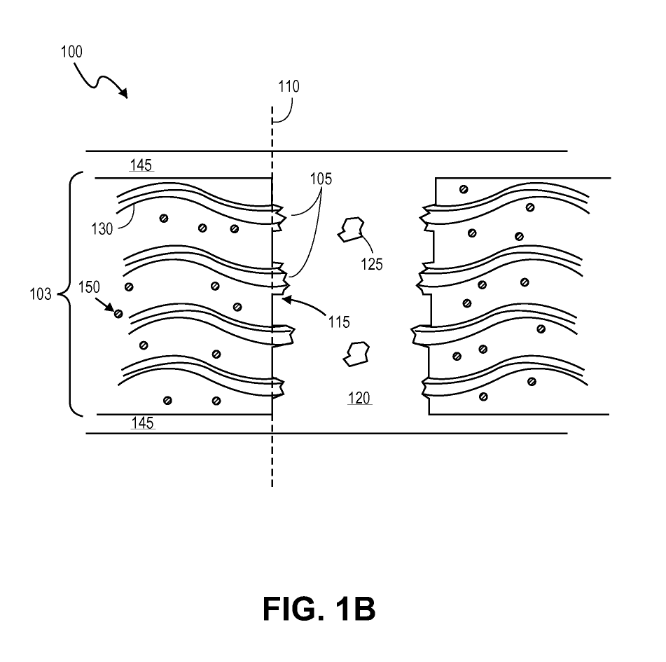

Generally, the laser drilled through-holes 201 and 202 may be of any average diameter, however in a first embodiment is below 150 μm. In another embodiment the through-hole average diameter is between 50 μm and 100 μm. The thickness of the reinforced package substrate core 203 may vary considerably as dependent on the packaging application. In embodiments, the reinforced package substrate core 203 is more than 200 μm thick. In exemplary embodiments, the reinforced package substrate core 203 is at least 400 μm thick and may be 700 μm, or more, to support four, or more, build up layers. At these thicknesses, the substrate core 203 includes a plurality of fibrous reinforcement material layers 230. In the exemplary embodiments at least three fibrous reinforcement material layers 230 are present with a resin 240 disposed between the plurality of layers (whereas thinner cores may have only one reinforcement layer). Generally, the greater the core thickness and the number of reinforcement layers 230, the more a through-hole is prone to voiding (e.g., like the voids 125 of FIG. 1B) or entrapment of plating electrolytes.

In embodiments, a laser-drilled substrate core through-hole is filled with a fill metal and is substantially free of voids in the fill metal. Although only sidewalls of a through-hole may be plated with the centerline of the through-hole remaining open (i.e., not completely filled), in the exemplary embodiment shown in FIGS. 2A and 2B, the fill metal 220 is continuous from top to bottom of the through-holes 201 and 202 with no voiding. Referring to FIG. 2A, this complete and continuous fill is due, at least in part, to the through-hole sidewall 210 having first sidewall portions 205, passing through the fibrous reinforcement 230, that are substantially aligned with second sidewall portions 215, passing through the matrix 240 loaded with microfiller 250. The same characteristic is displayed for the one-sided tapered through-hole 202. In embodiments, the first and second sidewall portions 205, 215 are aligned with substantially no undercut of one sidewall portion relative to the other sidewall portion. More particularly, in embodiments, the change in through-hole diameter over a length encompassing two sides of the interface between a first sidewall portion 205 and an immediately adjacent sidewall portion 215 is no greater than the change in diameter over a same length encompassing only one or the other of the first and second sidewall portions 205, 215.

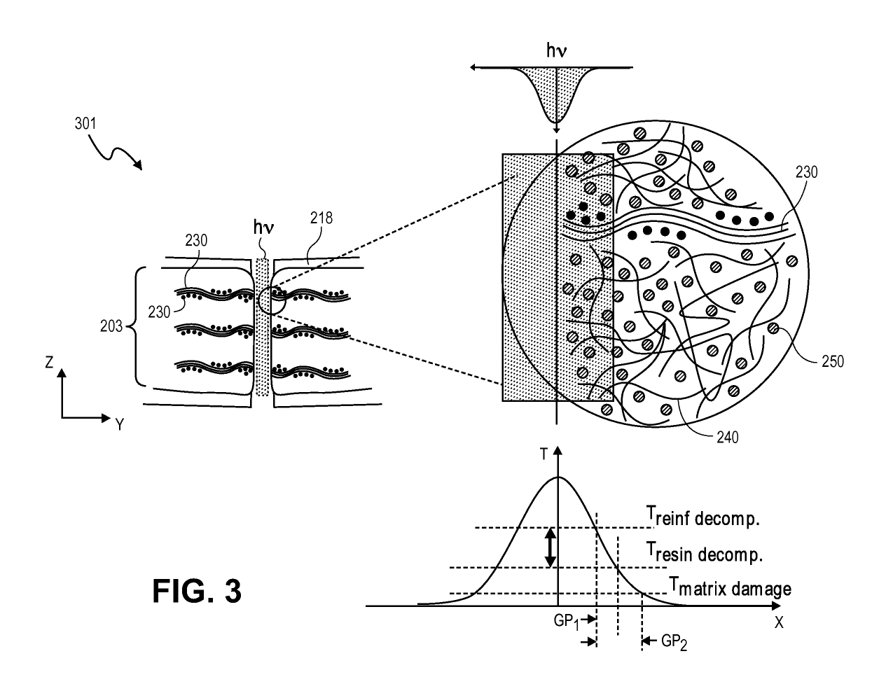

FIG. 3 is an illustration of a schematic showing the interaction of laser light with a reinforced core material 203, in accordance with embodiments of the present invention. Generally, laser drilling is a photo-thermal process with the core material 203 being a two component system consisting of a reinforcement phase (e.g., the fibrous reinforcement material 230) and a resin-microfiller matrix phase (e.g., a polymer resin loaded with microfiller 250), as depicted in FIG. 3. It has been found that a thermal mismatch between the reinforcement phase and matrix phase is a major contributor of fiber protrusion (FP₁αƒ(T_{reinf decomp}−T_{matrix decomp})), where T_{reinf. decomp} is the decomposition temperature of the reinforcement fabric and T_{matrix decomp} is the decomposition temperature of the resin+microfiller phase.

For an exemplary incident energy having a Gaussian distribution, it has been found that the energy tail extending away from the central longitudinal axis (i.e., centerline) of the through-hole into the interior of the core 203 damages the crosslinking of the resin 240 but does not cause direct material removal. However, this damaged resin is easily removed during post-processing (e.g., a desmear process) and in general, an increase in fiber protrusion is observed after a desmear step subsequent to laser drilling. This effect of thermal stability on fiber protrusion may be characterized as, FP₂αƒ(T_{reinf decomp}−T_{matrix damage}), where T_{matrix damage} is the temperature at which the resin phase becomes damaged displaying an increased susceptibility to desmear, and is indicative of its thermal stability.

In embodiments of the present invention, one or more of FP₁ and FP₂ are reduced. In a first embodiment, reducing the thermal contrast between the materials in the substrate core 203 entails reducing the decomposition temperature of the reinforcement material 230 below that of a conventional glass (e.g., silica) cloth. The rate at which the reinforcement is ablated then increases to be more comparable with that of the loaded resin 240. In embodiments, the fibrous reinforcement material 230 has a decomposition temperature which is within 300° C. of the decomposition temperature of the microfiller loaded resin 240. With exemplary polymer resins 240 decomposing at a temperature of about 350° C., the upper limit on decomposition temperature for the reinforcement material 230 is about 650° C., or less. Glass cloth, in contrast, decomposes at a temperature of about 850-1050° C. (depending on glass cloth composition).

In embodiments, the reinforcement material 230 comprises polymer fibers. While any of the many fibrous polymer materials known in the art may find application as the reinforcement material 230, those with mechanical properties most like glass are advantageous from the standpoint of a straightforward migration from glass fiber. High fiber strength, specifically having tensile strength at least equal to glass cloth fibers, is particularly advantageous. Exemplary embodiments of the fibrous reinforcement material 230 include, and optionally consists only of, aramids, and these embodiments have been verified to reduce thermal mismatch, and indeed reduce the protrusion of the fibrous reinforcement material into a laser drilled through-hole. The aramid class of fibrous polymer materials have excellent reinforcement properties from a mechanical standpoint. Such materials also have a low coefficient of thermal expansion (CTE) that is beneficial for utilization in substrate cores. One exemplary aramid is poly-phenylene terephtalamide (PPTA) commercially available under the trade name of Kevlar®. Other aramid embodiments are commercially available under the trade names Technora® and Twaron®. In another embodiment, the fibrous reinforcement material 230 includes, and optionally consists only of, Zylon® (poly(p-phenylene-2,6-benzobisoxazole). Liquid crystal polymer (LCP) formulations may also be employed as the fibrous reinforcement material. In one embodiment, the fibrous reinforcement material 230 may include, and optionally consists only of, an aromatic polyester polymer. One exemplary aromatic polyester polymer is commercially available as Vectran®, which is an aromatic polyester produced by the polycondensation of 4-hydroxybenzoic acid and 6-hydroxynaphthalene-2-carboxylic acid).

While these exemplary fibrous polymer materials have relatively high decomposition temperatures (e.g., 425-500° C. and 650° C. for Zylon®) for polymers, the 200-400° C. reduction in T_{reinf. decomp} relative to glass has been found to reduce the protrusion of the fibrous reinforcement material into a laser drilled through-hole, in some embodiments to the point where there is no measureable undercut of the resin 240 for a CO₂ laser based drilling process.

In other embodiments, the decomposition temperature of the microfiller loaded resin 240 (i.e., T_{resin decomp}) is increased. Generally, any increase in the resin decomposition temperature relative to that for a resin conventionally loaded with inorganic microfiller should reduce undercutting of the resin during the laser ablation process. Increasing the microfiller volume, the microfiller decomposition temperature, or the resin thermal stability all serve to raise the decomposition temperature of the resin matrix phase. This lowers the matrix-reinforcement thermal mismatch, as does decreasing the reinforcement decomposition temperature.

In preferred embodiments, T_{resin decomp} is brought to within 300° C. of the fibrous reinforcement material 230 decomposition temperature (T_{reinf. decomp}) by increasing least one of the microfiller volume or the microfiller melting temperature. In certain such embodiments, the microfiller loaded resin comprises 40-75 wt % microfiller with 60-70 % being a preferred range for greatest reduction in undercut of the resin 240 while maintaining a reasonably low resin melt viscosity (which increases with microfiller content and can impede processing at compositions exceeding 70 wt %). Such increases in microfiller content are useful, even where low melting temperature microfillers are employed.

In a second embodiment, the microfiller 250 has a very high melting or decomposition temperature. In certain such embodiments, the microfiller 250 is a material with decomposition temperature over 1600° C. Other important characteristics of a suitable microfiller are low coefficient of thermal expansion and homogenous particle size distributions. In one exemplary embodiment, the microfiller includes aluminum oxide (Al₂O₃, with a melting temperature of 2030° C.). In other embodiments, the microfiller includes or beryllium oxide (BeO, with a melting temperature of 2550° C.) or magnesium oxide (MgO, with a melting temperature of 2800° C.) or zinc oxide (ZnO, with a melting temperature of 1975° C.) or rutile titanium dioxide (TiO₂, with a melting temperature of 1640° C.). In another embodiment, silicon carbide (SiC, with a melting temperature of 2700° C.) microfiller is utilized.

With fillers having such high melting points, the microfiller loaded resin may comprise a reasonably low wt % (e.g., 20-40 wt %) for best melt viscosity, although a further increase in resin decomposition temperature may be achieved in embodiments where the resin has 60-70 wt % high melting temperature filler. As such, in certain embodiments, both microfiller composition and content level within the matrix are modulated to reduce thermal contrast within core materials.

Further embodiments of the present invention reduce mismatch between the optical absorption of the microfiller loaded resin 240 (i.e., matrix phase) and the fibrous reinforcement material 230. Because laser drilling is photo-thermal in nature, reduction in optical absorption mismatch can further reduce the protrusion of the fibrous reinforcement material into a laser drilled through-hole, in some embodiments to the point where there is no measureable undercut of the resin 240 for a CO₂ laser based drilling process even where some thermal contrast is present.

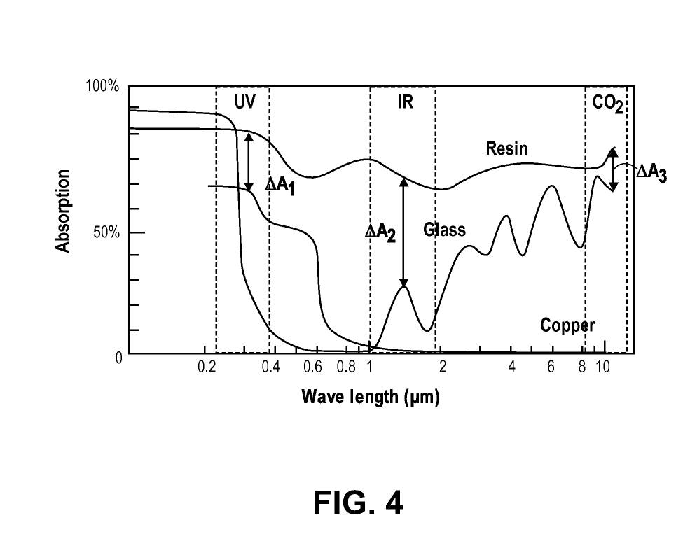

FIG. 4 shows absorption spectra depicting an absorption delta ΔA between relative absorption amounts for a polymer resin, glass (silica) cloth fibers, and copper cladding typical in a conventional package substrate core, which is reduced in an embodiment of the present invention. As shown in FIG. 4, the optical absorption of the resin 240 is consistently higher than that of the glass reinforcement for laser bandwidths of particular interest (i.e., 248 nm to 10.6 μm). Within this range, the optical absorption delta is more or less extreme. For example, within the IR band absorption of the resin is approximately twice that of the glass reinforcement (ΔA₂), with the UV band (0.248 μm-0.355 μm) and CO₂ laser band (9.4 μm-10.6 μm) being somewhat less (ΔA₁≅20% and ΔA₃≅10%).

In embodiments, the reinforcement material 230 has an absorption coefficient which is no more than 5% less than that of the microfiller loaded resin for incident laser radiation having a wavelength between 248 nm and 10.6 μm. In advantageous embodiments, the reinforcement material has an absorption coefficient which is at least as high as that of the microfiller loaded resin for incident laser radiation having a wavelength between 248 nm and 10.6 μm. In preferred embodiments, in part because some thermal contrast may remain between the reinforcement material and the microfiller loaded resin matrix, the reinforcement material has an absorption coefficient which is higher that of the microfiller loaded resin for radiation having a wavelength between 248 nm and 10.6 μm.

As the optical absorption and thermal decomposition parameters of a given material can be modulated independently, embodiments may enlist a two-prong approach to improving a laser-drilled through-core via sidewall profile. One exemplary two-prong approach entails decreasing T_{reinf decomp} and increasing optical absorption of the reinforcement material for at least one wavelength within a given laser bandwidth, such as within the 248 nm and 10.6 μm band, and more particularly for the CO₂ laser embodiment, within the 9.4 and 10.6 μm band. Another two-prong approach entails increasing T_{matrix damage}, for example by increasing the microfiller decomposition temperature, and increasing the optical absorption of the reinforcement material for wavelengths within a given laser bandwidth, such as within the 248 nm and 10.6 μm band, and more particularly for the CO₂ laser embodiment, within the 9.4 and 10.6 μm band.

In an embodiment, optical mismatch of the core material phases is reduced through the selective introduction of chromophores that increase the absorption of one phase relative to another. In one embodiment, the fibrous reinforcement material 230 contains a chromophore. Generally, the chromophore may be any material capable of increasing optical absorption of the reinforcement material for at least one wavelength within a given laser bandwidth, such as within the 248 nm to 10.6 μm band, and more particularly for the CO₂ laser embodiment, within the 9.4 μm to 10.6 μm band. This serves to increase the ablation rate of the reinforcement material 230 relative to the resin 240.

Many colorants containing suitable chromophores are known in the art for both polymer reinforcement material embodiments (e.g., para-aramids) described herein as well as for glass reinforcement embodiments with subsets of these having varying degrees of absorption within a given laser bandwidth. For example, chromophores including a C—O functional group have a strong stretching mode within the CO₂ laser wavelength regime, as does C═S and Si—O—R, where R is alkyl. Chromophores may be added to a given fibrous reinforcement material as an additive during manufacture or can be applied post-manufacture as a surface treatment. Depending on whether a low T_{reinf decomp} material is employed in conjunction with a colorant, embodiments include a colorant containing the chromophore may be added either to a polymer fiber or added to a glass fiber. Suitable chromophore containing colorants for the fibrous reinforcement include, but are not limited to, polyphenyl 2, cyanine, pyrylium, thiapyrylium, squarylium, croindoaniline, azo compounds (compounds bearing the functional group R—N═N—R′, in which R and R′ can be either aryl or alkyl), metalated azo, anthraquinone, naphthoquinone, aminium radical salt, phthalocyanine, naphthalocyanine, bis(dithiolene) and thiobenzophenone.

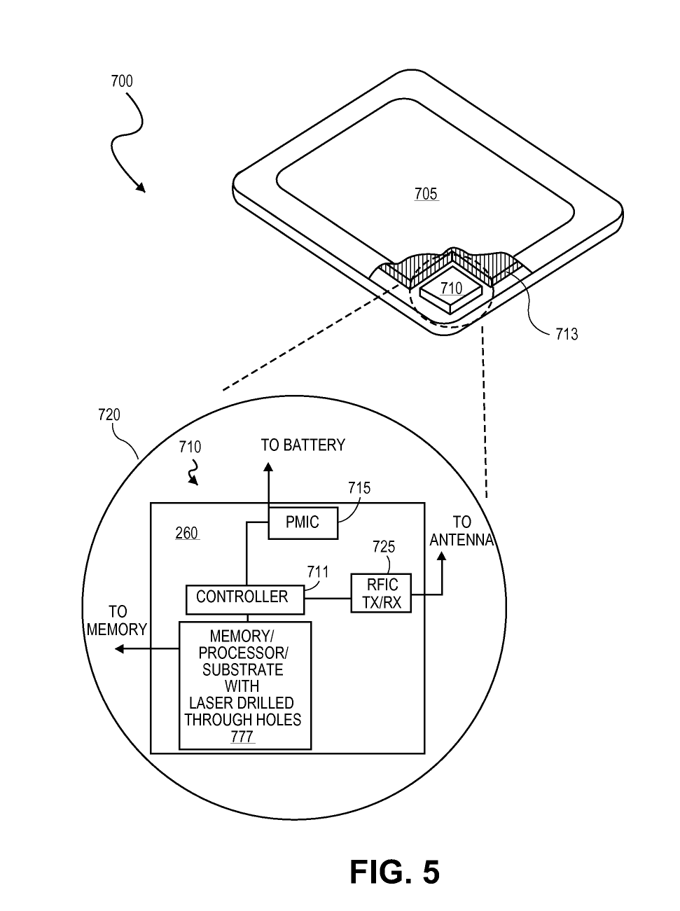

FIG. 5 is a functional block diagram of a mobile computing platform 700 which employs the package substrate core 203 in accordance with embodiments of the present invention. In the exemplary embodiment illustrated, not only does the platform 700 include the package substrate core 203, but further comprises the laser drilled through hole (e.g., 201 or 202 illustrated in FIGS. 2A and 2B). The mobile computing platform 700 may be any portable device configured for each of electronic data display, electronic data processing, and wireless electronic data transmission. For example, mobile computing platform 700 may be any of a tablet, a smart phone, laptop computer, etc. and includes a display screen 705 which in the exemplary embodiment is a touchscreen (capacitive, inductive, resistive, etc.), a chip-level (SoC) or package-level integrated system 710, and a battery 713. As illustrated, the greater the level of integration system 710 enabled by a reduced pitch of the substrate core through-holes of the laser drilled embodiments described herein, the greater the portion of the mobile computing platform 700 that may be occupied by the battery 713 or non-volatile storage, such as a solid state drive, for greatest platform functionality. As such, substrate core materials improving laser drilling of a core, particularly thick cores of greater than 400 μm, enables further performance and form factor improvements of the mobile computing platform 700.

The integrated system 710 is further illustrated in the expanded view 720. In the exemplary embodiment, packaged device 777 includes at least one memory chip (e.g., RAM), or at least one processor chip (e.g., a multi-core microprocessor and/or graphics processor), disposed on a substrate with laser drilled through holes. The packaged device 777 is further coupled to the board 260 along with, one or more of a power management integrated circuit (PMIC) 715, RF (wireless) integrated circuit (RFIC) 725 including an RF (wireless) transmitter and/or receiver (e.g., including a digital baseband and an analog front end module further comprises a power amplifier on a transmit path and a low noise amplifier on a receive path), a controller thereof 711. Functionally, the PMIC 715 performs battery power regulation, DC-to-DC conversion, etc., and so has an input coupled to the battery 713 and with an output providing a current supply to all the other functional modules. As further illustrated, in the exemplary embodiment the RFIC 725 has an output coupled to an antenna to provide to implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. Alternatively, each of these board-level modules may be integrated onto separate ICs coupled to the package substrate of the packaged device 777 or within a single IC (SoC) coupled to the package substrate of the packaged device 777.

Substrate cores for laser through hole formation have been described. In an embodiment, a package substrate core, comprises a plurality of layers of fibrous reinforcement material and a microfiller loaded resin disposed between the plurality of layers. The fibrous reinforcement material may advantageously have a decomposition temperature which is within 300° C. of the decomposition temperature of the microfiller loaded resin. In further embodiments, the reinforcement material comprises polymer fibers, such as an aramid or an aromatic polyester. In embodiments, the polymer comprises poly(p-phenylene-2,6-benzobisoxazole. In embodiments, the microfiller loaded resin comprises 40-70 wt % microfiller and the microfiller may further have a melting temperature higher than 1600° C. In embodiments, the microfiller comprises Al₂O₃. In other embodiments, the microfiller is at least one of: MgO, BeO, ZnO, TiO₂, or SiC.

In further embodiments, a chromophore may be added to a fibrous reinforcement material to modulate optical absorption of the material. In embodiments, the chromophore imparts the reinforcement material with an absorption coefficient which is at least as high as that of the microfiller loaded resin for radiation having a wavelength between 248 nm and 10.6 μm. In embodiments, the chromophore absorbs radiation wavelengths of 9.4-10.6 μm. In embodiments, the chromophore is at least one of: polyphenyl 2, cyanine, pyrylium, thiapyrylium, squarylium, croindoaniline, azo compounds, metalated azo compounds, anthraquinone, naphthoquinone, aminium radical salt, phthalocyanine, naphthalocyanine, bis(dithiolene) and thiobenzophenone.

In embodiments, a through-hole in a package substrate core is formed by laser drilling through the package core with a CO₂ laser. In further embodiments, the laser drilling forms a through-hole having first sidewall portions passing through the plurality of reinforcement material layers and second sidewall portions passing through the microfiller loaded resin with the first and second sidewall portions aligned as there is no undercut of one sidewall portion relative to the other sidewall portion.

Although many exemplary embodiments are described herein, it will be recognized that the invention is not limited to the embodiments described, but can be practiced with modification and alteration without departing from the scope of the appended claims. The scope of the invention should, therefore, be determined with reference to the appended claims, along with the full scope of equivalents to which such claims are entitled.

1. A package substrate core, comprising:
a plurality of layers of fibrous reinforcement material; and
a microfiller loaded resin disposed between the plurality of layers, wherein the fibrous reinforcement material has a decomposition temperature which is within 300° C. of the decomposition temperature of the microfiller loaded resin.

2. The package substrate core of claim 1, wherein the reinforcement material comprises polymer fibers.

3. The package substrate core of claim 2, wherein the polymer comprises an aramid or an aromatic polyester.

4. The package substrate core of claim 2, wherein the polymer comprises poly(p-phenylene-2,6-benzobisoxazole.

5. The package substrate core of claim 1, wherein the microfiller loaded resin comprises 40-70 wt % microfiller.

6. The package substrate core of claim 5, wherein the microfiller has a melting temperature higher than 1600° C.

7. The package substrate core of claim 9, wherein the reinforcement material comprises a colorant containing the chromophore, and wherein the colorant is selected from the group consisting of: polyphenyl 2, cyanine, pyrylium, thiapyrylium, squarylium, croindoaniline, azo, metalated azo, anthraquinone, naphthoquinone, aminium radical salt, phthalocyanine, naphthalocyanine, bis(dithiolene) and thiobenzophenone.

8. The package substrate core of claim 6, wherein the microfiller comprises at least one of: Al₂O3, MgO, BeO, ZnO, TiO₂, or SiC.

9. The package substrate core of claim 1, wherein the fibrous reinforcement material comprises a chromophore having optical absorption within the 9.4 μm-10.6 μm band.

10. A package substrate core, comprising:
a plurality of layers of fibrous reinforcement material; and
a microfiller loaded resin disposed between the plurality of layers, wherein the fibrous reinforcement material comprises a chromophore.

11. The package substrate core of claim 10, wherein the reinforcement material has an absorption coefficient which is at least as high as that of the microfiller loaded resin for radiation having a wavelength between 248 nm and 10.6 μm.

12. The package substrate core of claim 10, wherein the reinforcement material comprises glass and a colorant containing the chromophore.

13. The package substrate core of claim 10, wherein the chromophore absorbs radiation wavelengths of 9.4-10.6 μm.

14. The package substrate core of claim 13, wherein the chromophore comprises at least one of: polyphenyl 2, cyanine, pyrylium, thiapyrylium, squarylium, croindoaniline, azo, metalated azo, anthraquinone, naphthoquinone, aminium radical salt, phthalocyanine, naphthalocyanine, bis(dithiolene) and thiobenzophenone.

15. A package substrate comprising:
a substrate core comprising:
a plurality of layers of reinforcement material comprising a chromophore; and
a microfiller loaded resin disposed between the plurality of reinforcement material layers, wherein at least one of:
the reinforcement material comprises polymer fibers, or
the microfiller has a melting temperature above 1600° C.;
a tapered through-hole disposed through the substrate core, wherein a diameter of the tapered through-hole varies along a longitudinal length of the through-hole; and
a metal filling the through-hole.

16. The package substrate of claim 15, wherein the tapered through-hole has first sidewall portions passing through the plurality of reinforcement material layers and second sidewall portions passing through the microfiller loaded resin, and wherein the first and second sidewall portions are aligned with no undercut of one sidewall portion relative to the other sidewall portion.

17. The package substrate of claim 15, wherein the reinforcement material has an absorption coefficient which is at least as high as that of the microfiller loaded resin for radiation having a wavelength between 0.35 and 10.6 μm.

18. The package substrate core of claim 15, wherein the polymer comprises an aramid or an aromatic polyester.

19. A method of forming a through-hole in a package substrate core, the method comprising:
laser drilling through the package core of claim 1 with a CO₂ laser.

20. The method of claim 19, wherein the laser drilling forms a through-hole having first sidewall portions passing through the plurality of reinforcement material layers and second sidewall portions passing through the microfiller loaded resin, and wherein the first and second sidewall portions are aligned with no undercut of one sidewall portion relative to the other sidewall portion.
